(19) United States
(12) Patent Application Publication
(10) Pub. No.: US 2025/0307709 A1
(43) Pub. Date: Oct. 2, 2025

(54) VECTOR EMBEDDER FOR NON-NATURAL LANGUAGE DATA

(71) Applicant: Commonwealth Bank of Australia, Sydney (AU)

(72) Inventors: Dan JERMYN, Sydney (AU); Luiz PIZZATO, Sydney (AU); Anna LEONTJEVA, Sydney (AU); Naomi Ranjbar KERMANY, Sydney (AU); Patrick SONGCO, Sydney (AU); Jack ELLIOTT, Sydney (AU)

(73) Assignee: Commonwealth Bank of Australia, Sydney (AU)

(21) Appl. No.: 19/093,075

(22) Filed: Mar. 27, 2025

(30) Foreign Application Priority Data
Mar. 28, 2024 (AU) 2024202048

(51) Int. Cl. G06N 20/00

(52) U.S. Cl. CPC G06N 20/00

(57) ABSTRACT

Described herein are systems and methods for training and using a vector embedder to generate vector embeddings for non-natural language data. The method of training the vector embedder includes: receiving the non-natural language data including a plurality of records, each record including a plurality of attributes; grouping the records into a plurality of windows based on a respective subject attribute of the records, each window including a predetermined number of records; sorting the windows in order based on an entropy value of each window; and training a deep learning model to vectorize the non-natural language data by initially training the deep learning model with a set of windows having an entropy value lower than a threshold entropy value to predict one or more attributes of a record in each window based on the other attributes of the records in the window.

### TECHNICAL FIELD

Aspects of the present disclosure are directed to systems and methods for vector embedding, and in particular to a new vector embedder for embedding non-natural language data.

### BACKGROUND

Background information described in this specification is background information known to the inventors. Reference to this information as background information is not an acknowledgment or suggestion that this background information is prior art or is common general knowledge to a person of ordinary skill in the art.

A vector embedder or embedding module is a fundamental component in many machine-learning models, for example, deep learning models. It has particular use in models used for natural language processing and other tasks such as categorizing data. These embedders typically convert discrete categorical variables, such as words or tokens, into vector representations in a high-dimensional space. The vector embeddings can then be used for performing various downstream tasks such as data classification, identification of intent, etc.

Existing vector embedders have been trained to vectorize natural language with great accuracy. However, such known embedders often perform sub-optimally when used to vectorize non-natural language data as they are unable to understand the context and/or similarity/dissimilarity in non-natural language data. Furthermore, existing models are not readily adaptable for application to non-natural language data.

Accordingly, there exists a need for improved systems and methods for converting non-natural language data into vector embeddings.

### SUMMARY

Computer implemented methods for vector embedding non-natural language data are described.

Described herein is a computer implemented method for training a vector embedder to generate vector embeddings for non-natural language data, the method including: receiving the non-natural language data including a plurality of records, each record including a plurality of attributes; grouping the records into a plurality of windows based on a respective subject attribute of the records, each window including a predetermined number of records; sorting the windows in order based on an entropy value of each window; and training a deep learning model to vectorize the non-natural language data by initially training the deep learning model with a set of windows having an entropy value lower than a threshold entropy value to predict one or more attributes of a record in each window based on the other attributes of the records in the window.

Also described herein is a computer processing system including: a processing unit; and a non-transitory computer-readable storage medium storing instructions, which when executed by the processing unit, cause the processing unit to perform the above-described method.

Furthermore, described herein is a non-transitory storage medium storing instructions executable by a processing unit to cause the processing unit to perform the above-described method.

### BRIEF DESCRIPTION OF THE DRAWINGS

In the drawings:

FIG. 1 is a block diagram of a networked environment, including a computer processing system and data store, in which various features of the present disclosure may be implemented.

FIG. 2 is a block diagram of a computer processing system with which various features of the present disclosure may be implemented.

FIG. 3 is a flowchart illustrating an example method for pre-processing data to train and fine-tune a vector embedder.

FIG. 4 is a flowchart illustrating an example method for pre-training a deep learning model for vector embedding of non-natural language data.

FIG. 5 is a block diagram of an example transformer model that may be utilized for vector embedding non-natural language data.

FIG. 6 is a flowchart illustrating an example method for fine-tuning the pre-trained deep learning model for vector embedding of non-natural language data.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description, numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

The present disclosure relates to systems and methods for vector embedding non-natural language data. Generally speaking, a vector embedding is a numeric vector representation of data in a multi-dimensional “embedding” space that can be easily understood by machine learning models for further processing. The closeness or separation between vectors in this embedding space represents contextual information such as semantic similarity in respect of such vectors. For example, vector representations that are closer in the embedding space are related to underlying data that is more thematically or semantically similar than data associated with vector representations that are further apart in the embedding space.

As discussed above, vector embedders for converting natural language data into vector embeddings exist. These are generally part of a larger machine learning model, such as a large language model (LLM). Such modules are configured to convert (or transform) natural language data into vector representations within a high-dimensional embedding space. Although there are many known embedders that function well for natural language data, these embedders perform sub-optimally when attempting to vectorize (i.e., generate a vector for a data object) of non-natural language data.

Aspects of the present disclosure introduce a new vector embedder for use in machine learning models (such as deep learning models) that is capable of accurately generating vector embeddings from non-natural language data, including time series data.

Some aspects of the present disclosure are directed to methods and system for pre-training and fine-tuning this new vector embedder and other aspects of the present disclosure are directed to methods and systems for utilizing the trained vector embedder to accurately convert non-natural language data into vector embeddings.

Pre-training of the vector embedder includes turning a non-natural language dataset into a symbol dataset, where each symbol acts as the vocabulary of the underlying model. The dataset is then windowed based on one or more predetermined criteria. Finally, a customized pretext task is used to train a deep leaning model using the windowed symbol dataset.

Fine-tuning the vector embedder includes using another customized pretext task to fine-tune the deep learning model using another windowed symbol dataset.

Once the embedder is pre-trained and fine-tuned, it can be used to convert non-natural language data into vector embeddings.

In one example, the non-natural language data may be transaction records. A transaction record is generally a stream of unstructured information that includes numeric data (e.g., amounts and dates), alphanumeric data (e.g., account numbers), special characters (e.g., transaction details or entity names), etc. It will be appreciated that this is merely an example and that the techniques described herein may be utilized for any other non-natural language data without departing from the scope of the present disclosure.

### Example Systems

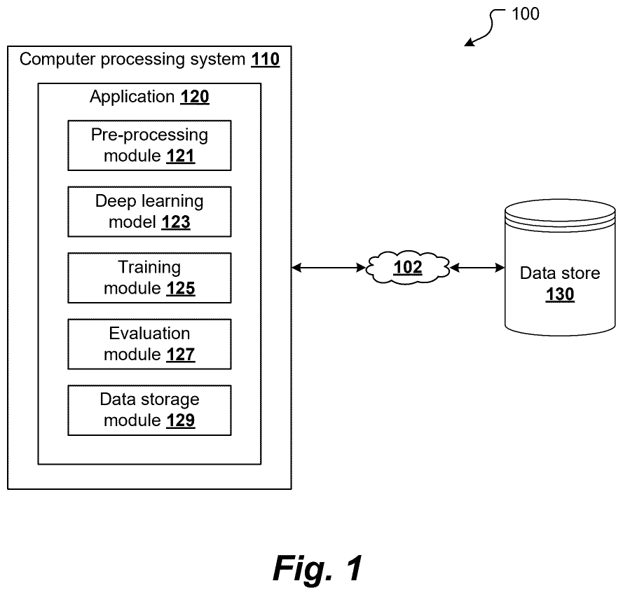

FIG. 1 illustrates an example computer processing environment 100 (environment 100 for short) in which embodiments and features of the present disclosure are implemented. Environment 100 includes a communications network 102, which interconnects a vector embedding system 110 (system 110 for short), and a data store 130. Via network 102 system 110 can communicate with (e.g., send data to and receive data from) the data store 130 and other computer processing systems (not shown). The techniques described herein can, however, be implemented on a stand-alone computer system that does not require network connectivity or communication with other systems. For example, all data required by the system 110 could be stored in a memory of the system 110.

The vector embedding system 110 may be a computer processing system, for example, a server system. The system 110 includes a vector embedding application 120 (application 120 for short).

The application 120 and its respective modules configure the system 110 to facilitate various functions and operations related to processing and vectorising data. These may include, for example, pre-processing data, vectorising the pre-processed data into a high-dimensional embedding space, and pre-training, fine-tuning and evaluating one or more deep learning models used for the vectorization. While system 110 has been illustrated with a single application 120, it may include multiple applications.

In one embodiment, the vector embedding application 120 includes a pre-processing module 121, a deep learning model 123, a training module 125, an evaluation module 127, and a data storage module 129.

The pre-processing module 121 is configured to pre-process data, for example non-natural language data for subsequent processing by the application 120 and the remaining modules. In some embodiments, the pre-processing module 121 may pre-process data by transforming representations of data from one format into another format, sorting and/or grouping the data. Further still, the pre-processing module 121 may retrieve data (e.g., unprocessed and/or unsorted data) and store data (e.g., processed and/or sorted data) into data store 130.

The deep learning model 123 (which may be included in or incorporated with an embedding module) is a machine learning model configured to vectorize instances of data as vectors in a high-dimensional embedding space. To be able to do so, the deep learning model 123 may be pre-trained, fine-tuned and evaluated as described with reference to FIGS. 3-6.

The training module 125 is configured to pre-train and fine-tune the deep learning model 123 to generate accurate vector representations based on input data (retrieved from the data store 130).

The evaluation module 127 is configured to evaluate the accuracy of the deep learning model 123 once it has been trained. The evaluation determined by the evaluation module 127 may be used to further train and/or fine-tune the deep learning model 123. The evaluation module 127 may retrieve data (e.g., embeddings) and store data (e.g., evaluation data) to and from the data store 130.

The data storage module 129 is configured to receive and process requests to persistently store and retrieve, to and from data store 130, data relevant to the operations performed/services provided by the application 120. Such requests may be received from the application 120 (and its respective modules), other computer processing environment applications, and/or (in some instances) directly from client applications. The data storage module 129 may, for example, be a relational database management application or an alternative application for storing and retrieving data from data store 130.

Data relevant to the operations performed/services provided by the system 110 may include, for example, unprocessed transaction records, processed data, training data, vector data, evaluation data and other data as described herein.

In the present example, the modules 121-129 have been described as modules of application 120—for example as add-ons, plug-ins, or other software components that integrate with and expand the functionality of the application 120. The functionality provided by one or more of these modules could, however, be performed by separate/stand-alone applications/modules. For example, the deep learning model 123 may be hosted on a separate system and/or application. As a further alternative, the functionality provided by one or more of these modules could be native functionality of the application 120.

It will be appreciated that, although not shown, in some embodiments, the system 110 may be configured as a server system, and application 120 may be configured as a application 120, which executes to provide a client application endpoint that is accessible over communications network 102. Client applications on client computing systems (not shown) may then access various functionalities provided by application 120. For example, client applications may provide the non-natural language data to application 120 for processing and vectorising the non-natural language data. In such cases, where the client applications are web clients, the application 120 may be a web server which receives and responds to, for example, HTTP application protocol requests. Where application 120 serves native client applications, application 120 will be an application server configured to receive, process, and respond to API calls from those client applications. The system 110 may include both web server and application server applications allowing it to interact with both web and native client applications. In addition to the specific functionality described herein, the application 120 (alone or in conjunction with other applications) may provide additional functions that are typically provided by server systems—for example user account creation and management, user authentication, and/or other server side functions.

The computer processing system 110 components have been described as functional components, and may be implemented by hardware, software (data and computer readable instructions which are stored in memory and executed by one or more computer processing systems), and/or a combination of hardware and software.

The precise hardware architecture of the computer processing system 110 will vary depending on implementation, however may well include multiple computer processing systems (e.g. server computers) which communicate with one another either directly or via one or more networks, e.g. one or more LANS, WANs, or other networks (with a secure logical overlay, such as a VPN, if required).

The data store 130 is used for storing data related to functions performed by the application 120, for example, unprocessed data (e.g., non-natural language data), processed data (e.g., symbols derived from the non-natural language data), weights, and biases of the deep learning model, or vector embeddings thereof. Data store 130 may be any appropriate data storage device (or set of devices), for example one or more non-transitory computer readable storage devices such as hard disks, solid state drives, tape drives, or alternative computer readable storage devices. Furthermore, while a single instance of data store 130 is described, the environment 100 may include multiple instances of data stores.

Communications between the various systems in environment 100 are via the communications network 102. Communications network 102 may be a local area network, public network (e.g. the Internet), or a combination of both. While environment 100 has been provided as an example, alternative system environments/architectures are possible.

### Example System

The features and techniques described herein are implemented using one or more computer processing systems. For example, in networked environment 100 described above, the various functions performed by the system 110 are performed by one or more computer processing systems (e.g., server computers or other computer processing systems).

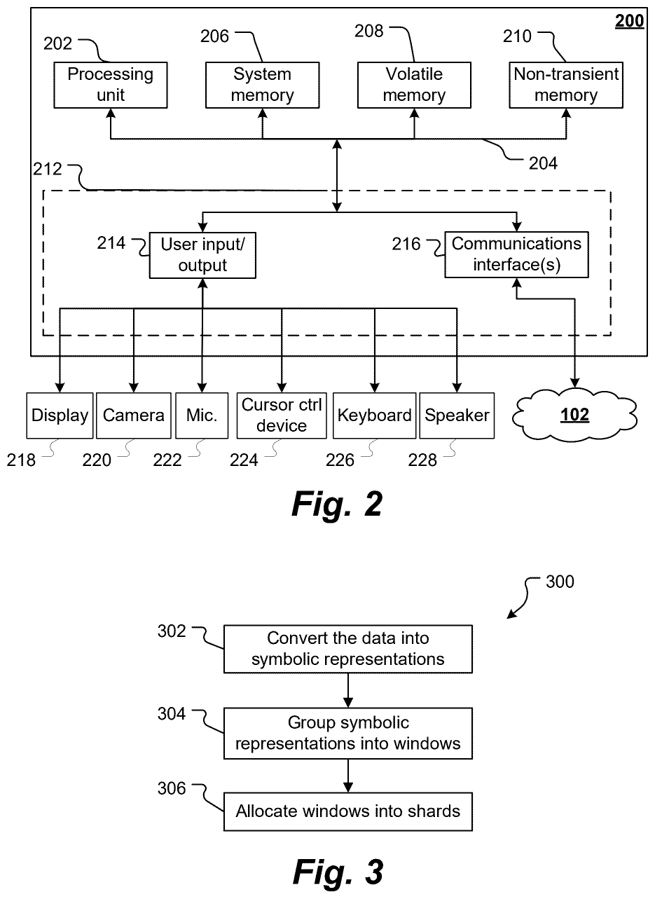

FIG. 2 provides a block diagram of a computer processing system 200 configurable to perform various functions described herein. For example, system 110 of FIG. 1 may be (or include) a computer processing system 200 such as that shown in FIG. 2 (although alternative architectures are possible).

System 200 is a general purpose computer processing system. It will be appreciated that FIG. 2 does not illustrate all functional or physical components of a computer processing system. For example, no power supply or power supply interface has been depicted, however system 200 either carries a power supply or is configured for connection to a power supply (or both). It will also be appreciated that the particular type of computer processing system determines the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g., a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable by (either in a shared or dedicated manner) system 200.

Through a communications bus 204, the processing unit 202 is in data communication with one or more machine readable storage (memory) devices which store instructions and/or data for controlling operation of the processing system 200. In this example system 200 includes a system memory 206 (e.g., a BIOS), volatile memory 208 (e.g., random access memory such as one or more DRAM modules), and non-volatile memory 210 (e.g., one or more hard disk or solid state drives).

System 200 also includes one or more interfaces, indicated generally by 212, via which system 200 interfaces with various devices and/or networks. Generally speaking, other devices may be integral with system 200, or may be separate. Where a device is separate from system 200, connection between the device and system 200 may be via wired or wireless hardware and communication protocols, and may be a direct or an indirect (e.g., networked) connection.

Wired connection with other devices/networks may be by any appropriate standard or proprietary hardware and connectivity protocols. For example, system 200 may be configured for wired connection with other devices/communications networks by one or more of: Universal Serial Bus (USB); eSATA; Thunderbolt; Ethernet; HDMI. Other wired connections are possible.

Wireless connection with other devices/networks may similarly be by any appropriate standard or proprietary hardware and communications protocols. For example, system 200 may be configured for wireless connection with other devices/communications networks using one or more of: infrared; BlueTooth; WiFi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are possible.

Depending on the particular system in question, devices to which system 200 connects include one or more input devices to allow data to be input into/received by system 200 and one or more output devices to allow data to be output by system 200. Example devices are described below, however it will be appreciated that not all computer processing systems will include all mentioned devices, and that additional and alternative devices to those mentioned may well be used.

For example, system 200 may include or connect to one or more input devices by which information/data is input into (received by) system 200. Such input devices may, for example, include a keyboard, a pointing device (such as a mouse or trackpad), a touch screen, and/or other input devices. System 200 may also include or connect to one or more output devices controlled by system 200 to output information. Such output devices may, for example, include one or more display devices (e.g., an LCD, LED, touch screen, or other display devices) and/or other output devices. System 200 may also include or connect to devices which act as both input and output devices, for example touch screen displays (which can receive touch signals/input and display/output data) and memory devices (from which data can be read and to which data can be written). By way of example, system 200 may include a display 218 (which may be a touch screen display), a camera device 220, a microphone device 222 (which may be integrated with the camera device), a cursor control device 224 (e.g., a mouse, trackpad, or other cursor control device), a keyboard 226, and a speaker device 228.

System 200 also includes one or more communications interfaces 216 for communication with a network, such as network 102 of FIG. 1 (and/or a local network within the system 110). Via the communications interface(s) 216, system 200 can communicate data to and receive data from networked systems and/or devices.

System 200 may be any suitable computer processing system, for example, a server computer system, a desktop computer, a laptop computer, a netbook computer, a tablet computing device, a mobile/smart phone, a personal digital assistant, or an alternative computer processing system.

System 200 stores or has access to computer applications (which may also be referred to as computer software or computer programs), for example application 120 and other applications. Such applications include computer readable instructions and data which, when executed by processing unit 202, configure system 200 to receive, process, and output data. Instructions and data can be stored on non-transitory machine readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, and referring to the environment 100 of FIG. 1 above, system 110 includes one or more systems 200, which run an application 120 to perform various operations described herein. In some cases part or all of a given computer-implemented method will be performed by system 110 itself, while in other cases processing may be performed by other devices in data communication with system 110.

### Example Data Structures

Non-natural language data, for example, data for pre-processing, data for training a deep learning model, and/or data for embedding into a vector space may be stored in various formats.

An example of a format for storing non-natural language data may be a database table including a set of attributes stored as key-value pairs. As used herein the term record may refer to an instance of data in such a database. In such a format, each pair may include a key-field defined by a respective key, and a value-field including one or more values corresponding to the respective key. Non-natural language data may thus include one or more records, each record having one or more attributes.

The attributes may include e.g., identifiers, entities, dates, numbers, or other attributes in respect of the record. Additionally, attributes may include a unique primary key by which each record is primarily identified. Alternative data formats are also possible and the processing described herein may be adapted for alternative formats.

As mentioned previously, transaction data may be one example of non-natural language data. Transaction data, in respect of information on one or more transactions may be stored in a transaction database as one or more transaction records. Generally speaking, each transaction record includes a number of attributes in respect of transactions. To assist with understanding of the present disclosure, a partial example of a database storing transaction records may be as in table A below:

TABLE A
Example transaction records

| Entity | Counterparty | Amount | Date | Time |
|---|---|---|---|---|
| Account A | Super-Mart | $20.26 | 2023 Nov. 2 | 19:03:02 |
| Account A | Green Grocer | $53.68 | 2023 Nov. 5 | 11:30:20 |
| Account B | Super-Mart | $15.92 | 2023 Nov. 7 | 09:30:12 |
| Account A | Super-Mart | $33.86 | 2023 Nov. 12 | 17:05:11 |

In this example, each transaction record includes data for the following attributes—an entity, a counterparty, an amount, a date, and a time.

The entity refers to the party that sends the transaction amount. The counterparty refers to the party that receives the transaction amount. The entity attribute may thus store a unique identifier (e.g., an account identifier or a user identifier) of the sending entity. The counterparty attribute may store a unique identifier (e.g., an account identifier or a user identifier) of the counterparty.

The amount attribute stores the transaction amount (in this instance, a dollar value) transferred from the entity to the counterparty. The date attribute may store a day, month and year on which the transaction occurred. The time attribute may store a time at which the transaction occurred. Additional and/or alternative transaction attributes may be provided, e.g., a unique transaction ID, a category of the transaction, a payment type, a location, a postcode of the location where the transaction occurred, and/or other transaction attributes.

Transaction data may thus be structured as a set (e.g., an array) of records represented as a table, wherein each row is a transaction record and each column represents a respective attribute of the transaction records. Transaction data may include a vast number of transaction records, for example, in excess of a billion transactions.

The precise storage location for the transaction data (e.g., transaction records) will depend on the particular implementation. For example, in the networked environment 100 described above, transaction records may be stored at and retrieved from date store 130.

### Example Methods

Turning to FIG. 3, an example method 300 for pre-processing non-natural language data (e.g., transaction data) will now be described. The operations of method 300 are described as being performed by application 120 running on system 110 but may also be performed by additional or alternative computer systems. Additionally, whilst method 300 is described with reference to particular transaction data, the method is also applicable to alternative data and data formats.

At step 302, data records, for example, transaction data records are converted into symbolic representations to generate the vocabulary of the subsequently used deep learning model 123. To do so, the pre-processing module 121 may retrieve the transaction data, for example, from data store 130 and then convert the raw transaction data into symbolic representations.

As described previously, a particular transaction record includes an entity identifier; a counter party identifier; a decimal number as a dollar value amount of the transaction; a particular date; and a time. Entity and counterparty identifiers may include text, numbers and special characters, the quantities for amount, data and time may be substantially continuous values.

The pre-processing module 121 converts amounts in the transaction records into symbols by discretising the continuous values into predetermined quantiles. For example, it may convert amount values to the closest $10 range quantile. Many alternative quantiles and ranges are possible. In some cases, the last quantile range may be replaced with a range of ‘greater than’ a predetermined number. Similarly, the first quantile may be replaced with a range of ‘lesser than’ a predetermined number.

Dates and times may also be converted into recurring symbols. In one embodiment, the dates and times may be converted into symbols describing the hour of the day, the day of the week, and/or the month of the year. For example, the date and time 2023 Nov. 2, 19:03:02, may be converted into Thursday, November, 7 pm. It will be appreciated that any pattern of symbols may be utilized for presenting dates and times. For example, instead of the day of the week, the date may be represented as a week number of a particular month, e.g., first week, November. In other examples, the time may be presented as a quantile, e.g., between 5 pm-7 pm, or in a 24 hour format, e.g., 1900 instead of 7 pm.

The fields for entity/counterparty may already include identifiers, for example words describing the respective entity/counterparty, which are suitable as symbolic representations of the entity/counterparty. Accordingly, such entity/counterparty identifiers may be used as the symbol(s), respectively representing each entity/counterparty, without requiring conversion. In alternative embodiments, entity/counterparty identifiers may be replaced with symbolic representations, for example, generated by the pre-processing module 121.

An example of the transaction records of table A, converted into symbolic representations at step 302, may be as shown in table B below:

TABLE B
example symbolic representations after step 302

| Entity | Counterparty | Amount | Day | Month | Time |
|---|---|---|---|---|---|
| Account A | Super-Mart | 20-30 | Thursday | November | 7PM |
| Account A | Green Grocer | 50-60 | Sunday | November | 11AM |
| Account B | Super-Mart | 10-20 | Tuesday | November | 9AM |
| Account A | Super-Mart | 30-40 | Sunday | November | 5PM |

As can be seen in this table, the entity names such as Account A and Account B along with the counterparty names such as Super-Mart and Green grocer have been retained as symbols respectively representing the entities and counterparties. The amounts in the third column have been converted into quantiles having $10 ranges, the dates have been converted into day of the week (column 4) and month of the year (column 5), and the time has been converted into hour of the day (column 6).

Thus, in general unstructured and/or continuous values of data, such as the raw amount, date and time of transactions, are converted into structured and discrete values suitable for processing by the deep learning model 123. In alternative embodiments many alternative symbolic representations of transaction records and non-natural language data are also possible. The symbolic representations of transaction records may be stored in data store 130.

At step 304, pre-processing module 121 is configured to sort and group the processed transaction records into sets referred to herein as windows. To do so, the pre-processing module 121 selects a ‘subject attribute’ from the available attributes in the transaction records. A subject attribute may be an attribute of the data by which the data may be grouped, sorted, and/or analysed. The subject attribute may be any attribute of the transaction records, such as the entity, the counterparty, the amount, the date and/or the time and may be selected based on the desired focus for analysis. In one example, the selected subject attribute may be the entity attribute. However, it will be appreciated that any attribute in the transaction dataset can be selected as the subject attribute according to any desired focus for analysis. For example, if the dataset includes postcodes, the postcode attribute can be selected as the subject attribute for generating the windows.

Once the subject attribute is selected, windows of transaction records are generated based on the selected subject attribute. Each window includes a predetermined number of transaction records associated with a selected subject attribute. Further, each transaction record within a window has (or is) the same symbol for the selected attribute. For example, if the selected subject attribute is the entity attribute, each transaction record within a window is for the same entity. Similarly, if the selected attribute is postcode, each transaction record within a window has the same post code value.

The windows may be contiguous blocks of time, that is, the windows may include sequential records in respect of the subject attribute. In this way, the windows may provide time series information for analysis and processing. For example, pre-processing module 121 may generate windows of thirty sequential transactions (e.g. continuous in time) from the same entity or associated with the same postcode. In other examples, the size of the window may be smaller or larger than this value without departing from the scope of the present disclosure. In some embodiments, the window size is selected based on the required entropy, processing speed, accuracy, etc.

An example of windowed transaction records based on the entity attribute may be as shown in table C below:

TABLE C
example transaction windows representations after step 304

| | | | | | |
|---|---|---|---|---|---|
| Entity | Counterparty | Amount | Day | Month | Time |

Window 1

| | | | | | |
|---|---|---|---|---|---|
| Account A | Super-Mart | 20-10 | Thursday | November | 7PM |
| Account A | Green Grocer | 50-60 | Sunday | November | 11AM |
| Account A | Super-Mart | 30-40 | Sunday | November | 5PM |

| | |
|---|---|
| Account A | . . . |
| Account A | 30^{th} transaction by Account A in Window 1 |

Window n

| | | | | | |
|---|---|---|---|---|---|
| Account B | Super-Mart | 10-20 | Tuesday | November | 9AM |

| | |
|---|---|
| Account B | . . . |
| Account B | 30^{th} transaction by Account B in Window n |

The transaction dataset generally includes a vast quantity of transaction records, which may number in the billions. Accordingly, multiple (and potentially large numbers of) windows of a predetermined number of transaction records may be grouped in respect of a single entity. For example, Account A may have a sufficient number of transaction records in the transaction dataset to be the subject of a large number of windows before Account B becomes the subject of the nth window. Additionally, transaction datasets may include a vast number of accounts (i.e., in addition to Account A and Account B).

Additional or alternative windows and ordering are also possible, dependent on the nature of the data. For example, if transaction records additionally include postcode information, the transaction records can be windowed based on postcodes. For example, the records can first be sorted based on the postcode attribute and then windowed as described above, such that each window includes a predetermined number of transactions from a particular postcode.

Generally speaking, most deep learning models are sensitive to the amount of entropy in their input data—that is, the amount of randomness, uncertainty and diversity in training data-which can cause inaccuracy in the model's outputs and significantly extend the training required to improve the accuracy of the system. Ideally, the amount of entropy in input training data should be tightly controlled to improve the accuracy of the ultimate model by way of initially training the model with low entropy training data and progressively introducing higher entropy training data.

Accordingly, the pre-processing module 121 may be configured to sort and/or group the windows of transaction records in respect of their entropy. In the present context, entropy is calculated with respect to the expectation of a transaction occurring. That is, transaction records and/or windows may be sorted and grouped according to the frequency or probability of one or more attributes in respective records and/or windows occurring. The probability of an attribute occurring may be calculated based on the relative frequency of such an attribute across the full dataset. In one example, the transaction records may be sorted in respect of their subject attributes, i.e., in order of most frequently occurring values of the subject attribute before windowing the data. This way, the embedder can gradually learn from the most frequently occurring values of the subject attribute (e.g., the lowest entropy, most common entities or postcodes) in the transaction records then specialize to rarer and less frequently occurring values of the subject attribute (e.g., highest entropy, least common entities or postcodes).

The frequency of the subject attribute occurring is one example of controlling for entropy. Further sub-sorting or alternative sorting may also be possible, for example, sorting transactions secondarily (or tertiary and so on) by the most frequently occurring amount, day, month, time, counterparty, or by any other attribute included in the data records. In some embodiments, the probability of a particular record occurring may be calculated based on the product of the relative frequency of one or more of the attributes in the record. Given records may include multiple attributes, windows with commonly occurring subject attributes may include high or low variance of other attributes or include attributes with low or high probabilities of occurring (and thus, have relatively high or low entropy) across the records within the window. Additionally or alternatively, the entropy of training data may be controlled for by sorting windows based on the number of unique symbols included in each window and/or via sorting of windows into shards (described further below).

At step 306, the pre-processing module 121 is configured to allocate windows of transaction records into sets of windows, herein referred to as shards, which are horizontal partitions of the overall set of transaction records. In general, the pre-processing module 121 is configured to generate shards along a continuum of entropy from windows with relatively common symbols (e.g., subject, object, date, amount, and/or time symbols); to more varied windows with fewer common symbols; to windows with rare symbols and rare combinations of symbols.

Each shard includes one or more windows of transaction records. In one example, where the dataset includes billions of transaction records and where each window includes thirty transaction records, thousands of shards may be generated, each shard including many thousands, up to millions of windows. In alternative examples, alternative numbers of shards having alternative numbers of windows are also possible. Each shard may include the same or a different number of windows and not all windows in the dataset are necessarily allocated to a shard.

As used herein, the entropy of a shard refers to the likelihood of the windows (and respective transaction records and symbols) in the shard occurring relative to the whole dataset, wherein a relatively low entropy shard includes windows of common transaction records with a high probability of occurring. Conversely a relatively high entropy shard includes windows of rare transaction records with a low probability of occurring. Probabilities of transactions occurring may be based on the frequency of symbols (and combinations of symbols) in that transaction occurring across the dataset as a whole. Further, depending on the allocation and the underlying transaction dataset, the windows of transaction records within a shard may share a common subject attribute (e.g., entity) or respective windows within the shard may include different subject attributes. Windows of transactions within a shard may also share (or differ in respect of) any one or more attributes having similar (or different) symbols as attribute values. As used herein, the similarity (or dissimilarity) of a shard refers to the similarity of windows within the shard, wherein a relatively homogeneous shard includes windows similar to each other and a relatively heterogeneous shard includes windows dissimilar to each other.

To further explain the grouping of windows into shards and their properties, consider the case of exemplary pairs of windows. Each of the windows can vary in respect of how expected, surprising, or likely they are to occur (i.e. their respective entropy) and also in respect of how similar they are to other windows (i.e. how many symbols they share with other windows). In one example, the pair of windows may not share any symbols (i.e. they each contain different transactions from different entities for different amounts at different times to different counterparties) however, each window may have an equal relatively high probability of occurring because their respective different transactions are overall relatively common amongst the full dataset. A shard of such windows would have low entropy but be highly heterogeneous. On the other hand, a pair of windows may be similar (or substantially identical) in that all (or almost all) symbols and transactions of each window are shared (or overlap) with the other window, however, such windows may only include highly unlikely, very rare transactions with potentially unique symbols which do not otherwise occur elsewhere in the whole dataset. A shard of such windows would have very high entropy (relative to the whole dataset) but would be relatively homogeneous.

Two primary examples of shard allocations will be described below, in particular relatively homogeneous shards and relatively heterogeneous shards. However, many alternative shard allocations are possible. Additionally, the nature of entropy of a dataset may be a continuum such that even amongst relatively homogeneous or relatively heterogeneous shards, particular shards may include windows which may exhibit more or less entropy as a result of the likelihood, diversity and/or uniformity in respect of various symbols within each window. In the present context, relatively similar low entropy windows are allocated to shards to generate relatively homogeneous shards having relatively low entropy; relatively similar moderate entropy windows may be allocated to shards to generate relatively homogeneous shards having moderate entropy; and relatively similar high entropy windows may be allocated to shards to generate relatively homogeneous shards having relatively high entropy, in respect of the windows within the shards. That is, for relatively homogeneous shards, each window in the shard is generally similar to each other window in the shard, however, such windows in the shard may include more or less common or rare records and thus, the entropy of shards may also be along a continuum. As will be explained further below, relatively heterogeneous shards may also be generated along a continuum of entropy. By dividing the training dataset into shards along a continuum of entropy, training time can be accelerated and the deep learning model 123 can be forced to focus on the task of disambiguating.

In order to generate shards, the pre-processing module 121 is configured to sort windows based on their entropy and then determine the similarity and/or dissimilarity between windows. For relatively homogeneous shards, the pre-processing module 121 can then allocate windows into a shard based on a threshold amount of similarity between windows of transaction records. The similarity between windows is determined based on the number of shared symbols between windows.

In some embodiments, the windows may be sorted based on entropy according to the transaction records and symbols included in the window. In some embodiments, the windows may be sorted based on the most frequently occurring symbols for entities and/or other attributes. In one example, the overall probability of a window may be calculated based on the product of the probability of each of the records in the window. The windows may then be sorted in entropy order based on their overall probability (or likelihood). A window with high probability, relatively common records may be sorted as relatively low entropy. Conversely, a window with low probability, relatively rare records may be sorted as relatively high entropy. In alternative embodiments, alternative entropy sorting processes and alternative orders are also possible.

In one embodiment, the similarity determination is made based on a string distance (e.g., Levenshtein or Jaccard) between the entropy ordered set of windows calculated using locality sensitive hashing. In one example, the symbols in each window are divided into buckets or bins based on their values. Each bucket corresponds to a particular symbol (e.g., a particular entity or counterparty symbol) or a range of symbols (e.g., a range of month symbols, time symbols or day symbols). This way, the same or similar symbols fall into the same or nearby buckets. Then the pre-processing module 121 determines similarity between windows by identifying windows that share more of the same buckets. The string distance (e.g., Levenshtein distance, Jaccard similarity) is then computed between pairs of windows. Windows that have lower string distances are considered similar windows whereas windows that have longer string distances are considered dissimilar windows. Given similarity is based on string distance of hashed symbols, a window of a particular entropy having a short string distance to another similar window implies that the similar window is also of the same or a similar entropy level (i.e. contains the same or similar symbols having the same or similar probability of occurring).

The pre-processing module 121 is configured to determine a minimum spanning tree based on the computed string distance. A minimum spanning tree (MST) is generally used to find the subset of edges in a connected, weighted graph that forms a tree and includes every vertex (e.g., window) in the graph. The primary purpose of finding the MST is to connect all the windows in the graph with the minimum possible total edge weight. In the current context, the MST is first constructed using the string distances. An algorithm such as Kruskal's algorithm or Prim's algorithm may be used for this construction. The constructed MST represents the minimum set of edges that connect all the windows while minimizing the total edge weight. In this way, the MST links all windows, wherein spans of the MST indicate regions of similar windows including similar records and symbols and thus, likely having relatively similar entropy.

To generate relatively homogeneous (similar) shards, once the MST is constructed, edges with the highest weight (i.e., the highest string distances) are gradually removed. Each time an edge is removed, it separates the tree into two or more disconnected components and these represent potential shards of similar windows. The decision of which edges to cut can be based on a threshold criterion, such as a string distance between points within a shard. Edges with weights exceeding this threshold are removed, resulting in the formation of distinct shards. Advantageously, the MST of string distances is a computationally efficient process to quantitatively and controllably determine similar transaction windows. Windows are then assigned to shards based on their connected component in the pruned tree. Each shard thus created includes windows of a threshold similarity and thus, has an overall similarity of a threshold amount. In alternative embodiments, random spans of the MST may be assigned to shards. Each shard may include a predetermined number of windows. Further, each shard may include the same or a different number of windows.

Because the windows are sorted based on entropy and then the MST calculated, spans of the MST will represent regions of similar windows having similar entropy with an over representation of regions having relatively low entropy windows. Accordingly, the shards created in this manner are ensured to have relative homogeneity (and thus relatively similar entropy) between windows within the shard. Spans of windows from relatively low entropy regions of the MST may be allocated to a shard to create a homogeneous shard of relatively low entropy. Spans of windows from relatively high entropy regions of the MST may be allocated to a shard to create a homogeneous shard of relatively high entropy. Spans may be generated with windows from regions of the MST along a continuum of entropy.

Spans of windows from different regions of the MST having the same or similar entropy, may represent a further option for controlling training data to progressively introduce new information to a model. For example, a first homogeneous low entropy shard may include relatively common transactions from a first entity to a first set of counterparties and a second homogeneous low entropy shard may include relatively common transactions from a second entity to a second set of counterparties. The first and second entities, and the first and second set of counterparties may be different, however, the first and second homogeneous low entropy shards may include windows respectively having equal (or similar) relatively high probabilities of occurring. Variations of homogeneous high entropy (or any particular entropy level) shards may be generated in a corresponding manner. Accordingly, the shards created in this manner may provide a range of training data (and datasets) along a continuum of entropy.

To further explain the relatively homogeneous shards, consider a situation where a dataset of transaction records includes a plurality of varied transactions. Initially, transactions are ordered based on most frequently occurring entity (e.g., account). Accordingly, homogeneous shards would be expected to include multiple (if not all) windows to the same entity. Amongst substantially low entropy homogeneous shards, all transactions records in all windows may be common and substantially similar with potentially only a single (or relatively low number) of attribute values varying between all transactions in all windows of the span. For example, a shard may include transactions, which only vary in respect of time of day, or only vary in respect of the day of the week. Other shards may include transactions, which vary in respect of multiple attributes (e.g., amount and day of week, etc.), may include less common (or rare) attributes and may include windows in respect of different entities and/or counterparties. In this way, even amongst relatively homogeneous shards, such shards exist along a continuum from substantially low entropy shards of windows of transactions all from common entities to common counterparties up to higher entropy homogeneous shards where windows in the shard include rarer attributes, rarer transactions and/or a variety of amounts, days, times, counterparties, and combinations thereof. The relatively low entropy shards may be stored (e.g., via data storage module 129) in the data store 130.

Whilst in the above example, the windows are sorted based on entropy and then spanned into regions of an MST based on string distance, alternative processes are possible. For example, an MST may be constructed first; regions (i.e. spans) of the MST allocated into shards; and then the shards ordered based on entropy within the windows of the shards. In either case, the final set of relatively homogeneous shards includes shards of similar windows.

As outlined above, the relatively homogeneous low entropy shards may include relatively low entropy windows. This may be particularly suitable for initial and/or pre-training of deep learning models. However, for further pre-training, for complete training, and for fine-tuning of such models, it is advantageous to also utilise higher entropy shards and shards with diverse windows. Accordingly, at step 306 the pre-processing module 121 is also configured to generate relatively heterogeneous shards wherein each shard includes windows of records that are dissimilar to records of other windows within the shard. That is, for example, relatively heterogeneous shards will include windows of transaction records respectively to different entities. Low entropy heterogeneous shards will include common, frequently occurring windows, each window being dissimilar to each other window in the shard and particularly high entropy heterogeneous shards will include windows of rare transactions records further including high variance of counterparty, amount, day, month, and time within each of the respective windows.

To generate the relatively heterogeneous shards, in some embodiments, the pre-processing module 121 may retrieve the relatively homogeneous shards of windows from data store 130 and split these shards to form new shards. For example, the windows of the relatively homogeneous shards may be randomly shuffled into new relatively heterogeneous shards. Advantageously, this ensures a set of shards composed of windows that are highly dissimilar to each other and also further containing an element of randomisation between shards. Furthermore, the entropy of heterogeneous shards may be controlled for by allocating windows from different regions of the MST having the same entropy into the same shard. In this way, the relatively heterogeneous shards will include windows that are dissimilar to each other wherein the entropy of the windows may be high or low depending on the region of the MST from which they were selected. For example, a relatively heterogeneous low entropy shard may include different windows of transaction records, wherein each window is highly dissimilar to each other window in the span yet each window has a substantially similar, relatively high probability of occurring. Conversely, a relatively heterogeneous high entropy span may include different windows of transaction records, wherein each window is highly dissimilar to each other window in the span yet each window has a substantially similar, relatively low probability of occurring. Multiple, different heterogeneous spans may be generated having substantially the same level of entropy by allocating different combinations of windows from different regions of the MST having similar entropy to respective shards. Additional shards having alternative combinations of dissimilar windows or varying entropy are also possible. Accordingly, the shards created in this manner may provide a range of training data (and datasets) along a continuum of entropy.

Other techniques may also be adopted for generating the relatively heterogeneous shards using alternative processes. For example, after the string distances are computed and the MST is generated, the pre-processing module 121 may remove edges in the MST that correspond to shorter distances between windows to create shards that include edges having higher than a threshold weight or string distance. This way each shard includes windows that have a higher than threshold string distance between them. In one example, heterogeneous shards may be generated based on windows having the greatest string distance to ensure shards with particularly high dissimilarity between windows, irrespective of the entropy of particular windows. In another example, edges having lowest string distances may be interleaved with edges having higher string distances. Relatively heterogeneous shards may be stored in and retrieved from (e.g., via data storage module 129) the data store 130.

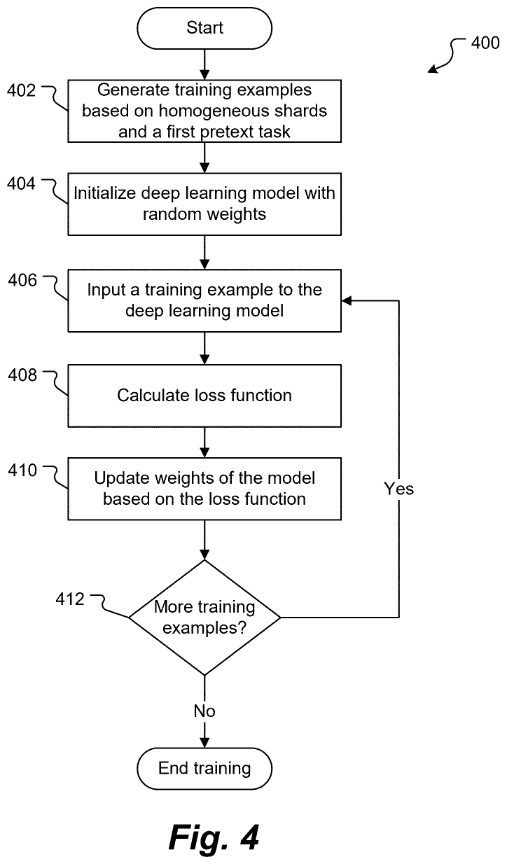

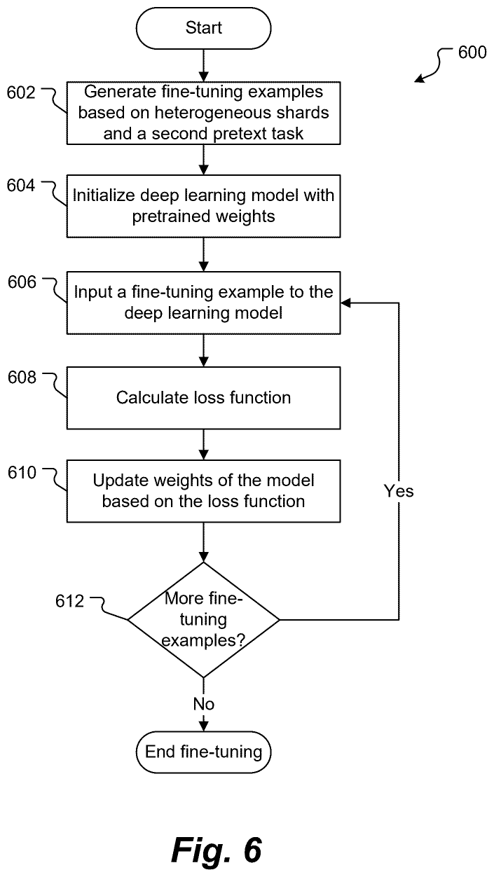

Once the shards are generated, the pre-processing method ends. Thereafter, in the following examples, the relatively homogeneous shards are utilized to pre-train the deep learning model 123 and the relatively heterogeneous entropy shards are utilized to fine-tune the model 123 as described with references to FIGS. 4 and 6.

FIG. 4 is a flowchart illustrating an example method 400 to pre-train the deep learning model 123 to generate vector embeddings. In one example, the deep learning model 123 may be implemented using a transformer architecture.

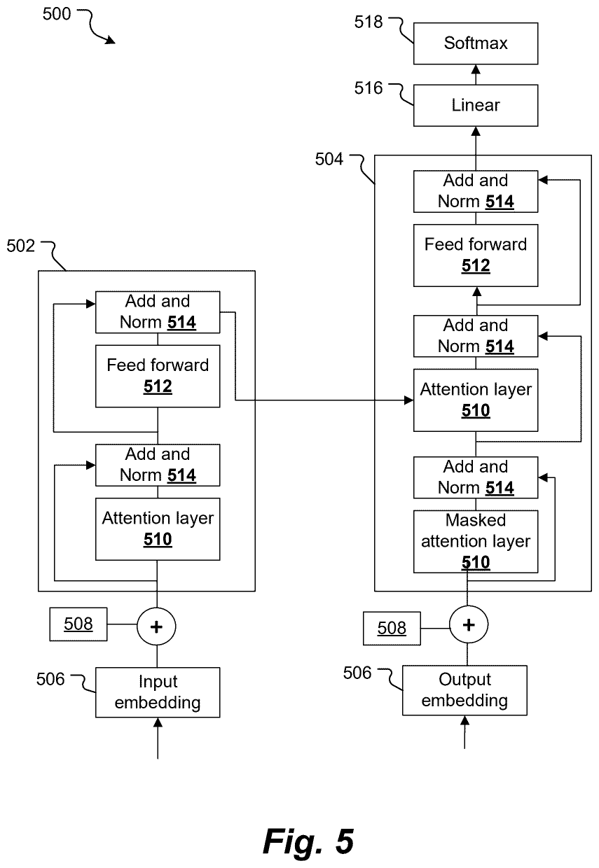

FIG. 5 illustrates an example encoder-decoder transformer architecture 500 that can be used in the deep learning model 123 described herein. The transformer architecture 500 includes one or more encoders 502 and one or more decoders 504. The encoders 502 receive the input samples and output a matrix representation of that input. The decoders 504 receive the encoded representation and generate an output. Each of these includes multiple layers.

In particular, the encoder 502 and the decoder 504 include one or more self-attention layers 510 that transform the input embeddings into queries, keys, and values to compute attention scores between pairs of symbols in the input data. The attention scores indicate the importance of each symbol relative to others in the input data. The attention scores may be utilized by these layers 510 to compute weighted sums of the values, resulting in contextualized representations for each symbol in the input data. The first attention layer 510 in the decoder 504 is a masked layer, in that it prevents positions from attending to subsequent positions such that each symbol in a sequence is not influenced by future symbols.

The encoders 502 and decoders 504 also include a feedforward neural network layer 512 that learns complex interactions and features from the representations generated by the self-attention layers 510. The self-attention 510 and feedforward neural network layers 512 are followed by residual connection and normalization layers 514 that add the output of each layer to the input of that layer, allowing gradients to flow directly through the transformer 500 during training and normalize the outputs of that layer to stabilize training and improve convergence. The output of the final encoder layer 502 is a set of vectors, each representing the input sequence with a rich contextual understanding. This output is then used as the input for the decoder 504.

In addition, the transformer architecture 500 includes an input embedding layer 506 before the first encoder 502 and decoder 504. The embedding layer 506 converts input data into vector embeddings. In particular, the input embedding layer 506 before the first encoder 502 converts input data into vector embeddings whereas the input embedding layer before the first decoder 504 converts the previous outputs of the transformer 500 into vector embeddings. It is this embedding layer 506 that is trained to accurately vectorize the non-natural language data during the pre-training and fine-tuning stages.

The transformer architecture 500 also includes a positional encoder 508 that provides information about the position of each symbol in the input. This positional information is combined with the vector embeddings before it is provided to the first encoder 502 and decoder 504. The transformer architecture 500 further includes an output layer that is passed through a linear transformation 516 followed by a softmax function 518.

It will be appreciated that the transformer architecture 500 may include additional and/or alternative layers (e.g., including pre-processing and post processing layers). Further, it will be appreciated that a transformer architecture is an example of the type of deep learning model 123 that can be trained to vectorize non-natural language data and that alternative deep learning model architectures may be utilized without departing from the scope of the present disclosure.

In general, the embedding layer 506 of the deep learning model 123 is configured to vectorize windows of input data into vector embeddings within an embedding space. The deep learning model 123 converts data into vector embeddings, that is, embeds data, based on one or more weighs and biases, which transform the data through the embedding and/or encoding layers. The weights utilised by the deep learning model 123 may be learned, trained and fine-tuned with respect to particular datasets and for particular processing tasks and desired outputs.

It will be appreciated that transformer 500 is merely an example architecture and that in other embodiments, the deep learning model 123 may be implemented using any other suitable architecture including a decoder-only transformer architecture, a recurrent neural network (RNN) architecture), a convolutional neural network (CNN) architecture, a combination of architectures, etc., without departing from the scope of the present disclosure.

In overview, during the pre-training process 400, a customized pretext task is used to build a general-purpose model. Pretext tasks generally refer to auxiliary tasks that are used to train a model in an unsupervised or weakly supervised manner. The primary goal of pretext tasks is usually to learn generalizable representations of the input data that capture meaningful patterns and structures, which can then be transferred to downstream tasks through fine-tuning. Accordingly, the selection of the pretext task does not only depend on the underlying dataset but also the type of downstream tasks that the model may be used for.

In one example, the pretext task may be to predict a counterparty based on one or more windows of transaction records. In the case of transaction records, this pretext task may be selected because counterparties are the most unpredictable element of a transaction record in a given window. Generally speaking, amounts, days, months and hours occur over and again across the vast number of transaction records which may be stored in data store 130, whereas many counterparties may only occur a relatively infrequent number of times. This makes counterparties equivalent to noun phrases in a natural language, in that they are relatively low-frequency terms that structure the subject matter of the transactions. Accordingly, by predicting a counterparty for a transaction record, the deep learning model 123 can learn generalizable representations of the transaction records that capture meaningful patterns and structures. Thus, for the sake of explanation, the pre-training described with respect to FIG. 4 can be seen as roughly equivalent to training the deep learning model 123 to speak a language. That is, to speak a non-natural language with respect to the subject and other attributes around which the data is pre-processed.

Returning to FIG. 4, the pre-training method 400 commences at step 402, where the training module 125 generates training data for the deep learning model 123 based on the selected pretext task and the low-entropy shards. As the low-entropy shards include relatively homogeneous windows of transactions with respect to relatively common entities, the low entropy shards are particularly suitable for pre-training and enable the deep learning model 123 to focus on the pretext task of disambiguating counterparties.

In one example, the training module 125 may initially generate training examples from the windows of relatively homogeneous shards that have an entropy value below a predetermined threshold entropy value. The ordering of the training examples is dependent on the order in which they are fed to the deep learning model 123. In this way, the model is initially pre-trained on similar training examples based on relatively low entropy windows having similar commonly occurring symbols. Accordingly, the training examples may be arranged such that all windows from the lowest entropy homogeneous shards are amongst the first training examples, whereas windows from the higher entropy homogeneous shards are amongst the later training examples. Training examples may also be generated in order using similar shards such that even as training examples increase in entropy, there is still a threshold level of similarity between each successive set of training examples. Training examples may be generated for each window in a shard. Alternatively a predetermined number of windows in a shard may be used to generate training examples before generating training examples from a different shard. Every window in every shard may be used to generate training examples, alternatively, where the dataset is of a significant size, only a subset or selection of windows of a subset or selection of shards may be used to generate training examples. In this way, an ordered set of training examples may be structured for initially training on predictable, similar and relatively simple examples and then progressively introducing new, different and increasingly complex data for training.

Each training example may include a window of transaction records, the window selected from a relatively homogeneous shard. Further, in each training example, a predetermined object attribute of the window may be masked based on the selected pretext task. For example, in the case of predicting the counterparty of the final transaction record as the object attribute, the counterparty symbol of the final transaction record in the window may be masked, whereas the counterparty symbols of the other transaction records in the window may be left unmasked. That is, in the case of a window of thirty transaction records, the thirtieth transaction record's counterparty symbol may be masked whereas the counterparty symbol of transaction records one to twenty-nine are not masked. Masking may be done by replacing the masked symbols with a special mask token to indicate that the symbols are masked. It will be appreciated that this is one example way of creating training examples and that any other mechanism and configuration of masked training examples can be utilized without departing from the scope of the present disclosure.

At step 404, the deep learning model 123 is initialized. This may include setting the weights of the various layers of the deep learning model 123 (e.g., the various layers of the transformer architecture 500) to random values or to predetermined values. In case predetermined values are utilized, the predetermined weight values for the various layers may be adapted from an existing transformer model, e.g., BERT. Weights are coefficients of the deep learning model 123 that are learned during training. Weights typically determine the transformation applied to the input data as it passes through the layers of the model 123. Additionally, many layers in the model 123 may include bias terms, which are constants added to the weighted sum of inputs. Biases help the model 123 learn the correct output even when all input values are zero. When initializing the model 123 with random weights, each weight and bias parameter in the model 123 may be set to a random value. These random values may be selected from a distribution with a mean of 0 (such as a normal distribution or a uniform distribution) and a small standard deviation.

Initializing the weights helps break symmetry and prevents neurons in the deep learning model 123 from computing the same function. If all weights were initialized to the same value, the neurons would produce identical outputs during forward propagation, and there would be no diversity in the model's behaviour. Random initialization ensures that neurons learn to extract different features from the input data.

At steps 406-412, the training module 125 is configured to train the deep learning model 123 to perform the pretext task of predicting the masked counterparties.

Initially at step 406, a first training example from the ordered set of training examples is fed to the deep learning model 123 in a forward pass. In case the transformer architecture 500 is utilized, this generally includes the input embedding layer 506 converting each symbol in the training example into a vector embedding, e.g., using an embedding lookup table that has been initialized with the random weights. The embedding of the masked symbol in the training example may be replaced with a special mask token.

Positional encoding vectors may be added to the input embeddings via the positional encoder 508 to provide information about the position of each symbol in the training example. These positional encodings allow the deep learning model 123 to understand the sequential order of symbols in the training example. The input embeddings with positional encodings are then passed through the encoder layers 502, where each encoder layer includes the self-attention layer 510 followed by the feedforward neural network layer 512.

The self-attention layers 510 compute attention scores between all pairs of vector representations of symbols in the training example. The self-attention mechanism computes weighted sums of the values based on the attention scores, resulting in contextualized representations for each token, the feedforward layer 512 learns complex interactions and features from the input representations, which are used for predicting the masked tokens. The output of the feedforward neural network layer 512 is passed through a linear transformation (at 516) followed by a softmax function (at 518). This produces the output probabilities for each masked symbol in the training example.

Accordingly, during the forward pass, the input training example is passed through each layer of the deep learning model 123 sequentially. Each layer transforms the input representations and enriches them with contextual information, ultimately enabling the deep learning model 123 to predict the masked tokens. The output of the last layer provides the predicted probabilities for the masked symbol.

At step 408, a loss function is determined. This is determined by comparing the predicted probabilities of the masked symbol with the ground truth—the actual unmasked name of the counterparty. In one example, the loss function may be a cross-entropy loss function. In alternative embodiments, alternative loss functions may be utilised.

At step 410, the loss function is back-propagated to update the weights and biases of each layer of the deep learning model 123 including the embedding layer 506.

At step 412, a determination is made whether any more training examples are to be input. For example a determination may be made as to whether any more training examples are left from the set of training examples generated at step 402. If a determination is made that one more training examples have still not been fed to the transformer model at step 412, the method returns to step 406 where the next training example is fed to the deep learning model 123. This process is repeated until a determination is made at step 412 that no more training examples are left. In which case, the training method 400 ends.

It will be appreciated that in the method described above, training ends when all the training samples are fed to the deep learning model 123. In other examples, the training may end when the loss function has been sufficiently minimized. In some embodiments, the training may be performed in respect of training examples from a particular shard and/or training examples having a particular (range of) entropy until the loss function substantially converges before proceeding to further training examples from alternative shards and/or training examples having greater entropy.

It will be appreciated that initially, the loss in the model will be high, as the deep learning model won't be able to accurately predict the masked symbols. However, as more and more training examples are fed to the model 123, the loss reduces as the model updates its weights to generate more accurate embeddings and more accurate representations of the training data.

Accordingly, the pre-training involves repeatedly performing the pretext task and updating the model. Advantageously, by ordering the training examples such that the pre-training is initially performed using relatively similar, relatively low entropy data and then progressively training the model 123 with higher entropy data, the model becomes better able to perform the pretext task more quickly. In the context of vector embedding, regions of the embedding space will be easier or harder to learn, based in part on how sparse the space and the dataset is. Accordingly, because the windows of transaction records may be allocated into relatively homogeneous spans as blocks of initially relatively common counterparties, to blocks of uncommon counterparties, then expanding up to blocks of relatively rare counterparties the model may be effectively pre-trained with input data of appropriate entropy. The model 123 may be further trained on alternative datasets and/or based on alternative pretext tasks.

FIG. 6 illustrates an example method 600 for fine-tuning the model 123. In overview, this fine-tuning stage involves adapting the model's learned representations to perform a particular task. In the present example, the intended downstream functionalities of the model may relate to predicting transactions. A fine-tuning task may therefore be selected that predicts a next complete transaction record based on a window of transaction records. That is, rather than predicting only the counterparty name for a transaction record in a window, the model is fine-tuned to predict an entire transaction record. This allows the fine-tuning method 600 to be specialised in two ways, the task differs (i.e., the task is now to predict a complete transaction record instead of predicting a counterparty) and the input data differs (i.e., an entire transaction record is masked instead of just the counterparty name).

Thus, for the sake of explanation, the fine-tuning is roughly equivalent to teaching the deep learning model to answer a set of questions in the language. Ultimately, the deep learning model is being fine-tuned to perform tasks in respect of that non-natural language, but also, it is being trained to optimally generate vector embedding of such a non-natural language into a high-dimensional embedding space so that it can perform such tasks.

The method 600 commences at step 602, wherein the training module 125 generates fine-tuning examples from the heterogeneous shards from data store 130. In one example, the training module 125 may generate an ordered set of fine-tuning examples from windows of the heterogeneous shards that have a predetermined entropy value that may initially be below a threshold entropy value and may progressively increase over the course of the fine-tuning examples. That is, the training module 125 may initially generate fine-tuning examples using a heterogeneous shard having low entropy before generating fine-tuning examples using heterogeneous shards having higher entropy. The ordering of the fine-tuning examples is dependent on the order in which they are fed to the deep learning model 123. The training module 125 may order the fine-tuning examples such that all examples generated from one shard are fed to the model 123 before fine-tuning examples from other shards are fed to the model. Because the relatively heterogeneous shards include dissimilar windows, the fine-tuning examples based on windows from the same shard will provide dissimilar instances of data for the fine-tuning examples to train the model. In addition to fine-tuning examples in the set containing windows dissimilar to each other, fine-tuning examples over the course of the set may include increasing entropy by generating training examples from shards of progressively increasing entropy.

Each fine-tuning example may include a batch of a predetermined number of windows (e.g., 2 or more windows) from a heterogeneous shard, where the windows are dissimilar to each other. Further, in each fine-tuning example, a predetermined number of the transaction records (e.g., 1) of each window may be masked. For example, the last transaction record in each of the windows may be masked whereas the other transaction records in the windows of that fine-tuning example are left unmasked. In this way, each fine-tuning example may include two dissimilar windows of transaction records, each window effectively including all transaction records except for the respective last masked transaction record. Masking may be done by replacing the masked symbols with special mask tokens to indicate that the symbols are masked. It will be appreciated that this is one example way of creating fine-tuning examples and that other mechanisms and configurations of masking and/or creating fine-tuning examples may be utilized without departing from the scope of the present disclosure. For example, in an alternative embodiment, instead of masking the final transaction in each window, a masked transaction record of mask tokens may be appended to each window and/or the fine-tuning task may be to predict a next transaction (rather than the final transaction record) of each window in each fine-tuning example.

Fine-tuning examples are not limited to specific numbers of windows in a batch. As a further example of a fine-tuning example, in the case of windows of thirty transaction records and heterogeneous shards having a million windows, each fine-tuning example may include a batch of a thousand dissimilar windows, the final (or next) transaction record in each window being masked for prediction as the fine-tuning task.

At step 604, the training module 125 is configured to initialise the deep learning model 123 based on the weights and biases determined at the end of the pre-training method 400.

At step 606, the training module 125 is configured to feed a fine-tuning example from the fine-tuning example set generated at step 602 to the deep learning model 123. This step is similar to step 406 and therefore is not described again in detail. During the forward pass, each window in the fine-tuning example is passed through each layer of the transformer architecture 500 sequentially. Each layer transforms the input representations based on its previously learnt weights and biases and enriches the representations with contextual information, ultimately enabling the model 123 to predict the masked tokens. The output of the last layer provides the predicted probabilities for the masked transaction record of each window in the fine-tuning example.

Due to the pre-training, the deep learning model 123 may be able to generally vectorize transaction data providing context to the transaction records in the fine-tuning example and thus, the model may be able to predict the masked transaction records.

At 608, a loss function is computed based on the input windows of the fine-tuning example and the respective outputs—i.e., the input records of each window and the respective predicted final (or next) transaction record of each window in the batch of windows in the fine-tuning example. In one example, the loss function is a contrastive loss function. This loss function quantifies the similarity or dissimilarity between the predicted outputs and the inputs of the fine-tuning example. In particular, the contrastive loss function seeks to minimize the distance between input embeddings and output embeddings for each window and to maximise the difference between embeddings of windows in the batch. That is, to minimise the distance between the respective embeddings of the input unmasked transaction records and the output predicted transaction of each window, and to maximise the distance between respective (input and output) embeddings of each window in the fine-tuning example.

Put another way, where a fine-tuning example includes a batch comprising a first window and a second window, the contrastive lost function seeks to minimize the distance between the embeddings of the input transactions of the first window and the output predicted final transaction of the first window; to also minimize the distance between the embeddings of the input transactions of the second window and the output predicted final transaction of the second window; and further to also maximize the distance from the embeddings of the first window to the embeddings of the second window.

As the fine-tuning example set includes batches of dissimilar windows from a heterogeneous shard, over the course of fine-tuning, the model is encouraged to minimize the difference between the inputs and outputs in respect of each window and to maximize the distance (or minimize the similarity) between the embeddings of dissimilar windows. In particular, it encourages similar window pairs to have low distance (or high similarity) embeddings and dissimilar window pairs to have high distance (or low similarity) embeddings in the embedding space. Advantageously, the fine-tuning examples being generated from heterogeneous shards enables effective contrastive learning via the contrastive loss function.

At step 610, the computed contrastive loss function is back propagated in the transformer architecture 500 to update the model parameters of the layers such that the contrastive loss can be minimized. In alternative embodiments, alternative loss functions may be utilised.

At step 612, a determination is made whether any more fine-tuning examples are to be input. For example, a determination may be made as to whether any more fine-tuning examples are left from the set of fine-tuning examples generated at step 602. If a determination is made that one or more fine-tuning examples have still not been fed to the model 123 at step 612, the method returns to step 606 where the next fine-tuning example is fed to the deep learning model 123. This process is repeated until a determination is made at step 612 that no more fine-tuning examples are left. In which case, the fine-tuning method ends.

It will be appreciated that in the method described above, fine-tuning ends when all the fine-tuning samples are fed to the deep learning model 123. In other examples, the fine-tuning may end when the contrastive loss function has been sufficiently minimized. In some embodiments, the fine-tuning may be performed in respect of fine-tuning examples from a particular shard and/or fine-tuning examples having a particular (range of) entropy until the loss function substantially converges before proceeding to further fine-tuning examples from alternative shards and/or fine-tuning examples having greater entropy.

The contrastive learning processes used in the fine-tuning stage requires dissimilar windows within the same shard. Advantageously, the relatively heterogeneous shards had been generated in such a way as to ensure diversity between windows of transaction records within the same shard. Accordingly, the model may be effectively fine-tuned based on contrastive learning utilising the dissimilar data windows within the relatively heterogeneous shards. Additionally, the fine-tuning may initially be performed in respect of shards that include relatively low entropy windows with relatively common entities (although with diversity between entities of each window and/or diversity between other attributes). As the fine-tuning progresses and the model becomes more capable in respect of the fine-tuning task, progressively rarer entities and progressively higher entropy shards may be introduced, further fine-tuning the model. Advantageously, this fine-tuning improves efficiency of the training of the model and ultimately specialises the embedding space of the model, yielding more precise results in the embedding. Fine-tuning may be repeatedly performed with fine-tuning examples from different shards until the loss function converges; until the embedding model is found to be sufficiently accurate, for example for downstream processes; or until improvements in evaluations of the embedding model (described below) indicate the fine-tuning has substantially minimised the difference between embeddings of input and output pairs. In some embodiments, the model 123 may be further fine-tuned on alternative datasets and/or based on alternative fine-tuning tasks.

Once the deep learning model 123 has been fine-tuned, the embedding space is ready for projecting new transaction record windows thereinto.

In some examples, the embedding space is evaluated. To evaluate the embeddings and model, the evaluation module 127 may validate that the same (or similar) object attributes, that is, counterparties are projected into the same (or substantially similar) embedding space, irrespective of how different or similar the transaction records are before the final transaction in a window or irrespective of how different particular attributes of the transaction records that share the same counterparty are.

The evaluation measure may be calculated at scale across the entire embedding space using a hold out dataset, for example a set of transaction windows that was not used in either pre-training or fine-tuning and that the embedding model has not seen. In particular, such a hold out dataset of transaction windows are embedded by the model 123 and the evaluation module 127 calculates a MST between the embeddings of the transactions of each window. In one example, the model predicts the final (or next) transaction for each window in the hold out dataset and the distance for the MST is based only on the distance between the embeddings of the predicted transaction record of each window. Other transaction records within windows are embedded but do not necessarily contribute to the MST. In an alternative example, only the embedding of the final counterparty of each window is included in the calculation of the MST. The evaluation module 127 then determines an average distance of spans in the minimum spanning tree, that is for example, the average distance between embeddings of the predicted final transaction record (or the predicted final counterparty) of windows linked in the minimum spanning tree.

This average distance is a concise representation of the accuracy of the embedding model, if the average is low (i.e., similar final embeddings of windows are relatively close in distance irrespective of prior transactions and/or prior attributes in respective windows) the embedding space of the model is evaluated as objectively better than a space with a higher average distance between the linked transaction windows. Projection of a hold out set of windows into the embedding space (as at 314) and evaluation thereof (as at 316) may be performed periodically after rounds of pre-training and/or fine-tuning to evaluate the embedding model as it is trained. Pre-training and/or fine-tuning may be repeated and/or continued until the evaluated average distance of final embeddings is determined to converge to a suitably low measurement indicating the model is relatively accurate and precise.

At the completion of the evaluation, the embedding model is fine-tuned to vectorize non-natural language data, in this example, transaction data into a vector space such that vectors of each attribute embedded into the embedding space convey semantic relationships to similar, relatively proximate vectors and overall indicate the context of attributes within transactions.

In the above described systems and methods, the non-natural language data is pre-processed to structure the data in varying sets and grades of progressively increasing entropy and/or rarity which enables faster, more efficient training of deep learning models for vector embedding and which results in more accurate embeddings by such models. Advantageously, because the model is initially pre-trained with respect to a pretext task, the model is able to generate optimal embeddings, which are inputs of the pretext task. Furthermore, the fine-tuning processes, including contrastive learning processes as described above, enable specialisation of the model to perform a desired task. The techniques described above also provide efficient processes for grouping, sorting and evaluating data, embedding models and resultant embeddings and embedding spaces. The efficiencies and advantages of the systems and methods disclosed herein are particularly significant given the scale of the datasets (e.g., including billions of records, each having respective attributes) to which the techniques may be applied.

The trained and fine-tuned embedding model may be stored in data store 130 and as required, the embedding model, weights and/or configurations may be retrieved, for example, by application 120 for implementation by an embedding module. The deep learning model 123 having been trained and fine-tuned, and then implemented may also be referred to as embedding module 123. With the trained and fine-tuned model, embedding module 123 may be configured to process sets of non-natural language data such as new sets of transaction records in order to vectorize the data as vectors into an embedding space and to process the data. The embedding module 123 (and/or application 120) may utilise the embeddings for various tasks and analysis and may make the embedding model, embeddings and/or analysis accessible to systems external to system 110. Examples of tasks and/or analysis which may be performed via the embedding model include predicting attributes based on historical data, for example predicting future transactions based on previous transactions. The embedding model may also be utilised to identify outliers, for example, to detect unusual and/or potential data amongst transaction records. These examples are not at all limiting and only encompass a brief range of possible uses for the embedding model. Furthermore, the utility of the trained embedding model is not limited to specific transaction data related analysis and may be extended to any required analysis and/or task with suitable adaptation in accordance with the above disclosed techniques.

The flowcharts illustrated in the figures and described above define operations in particular orders to explain various features. Still further, the functionality/processing of a given operation perfumed by a given system, application or module could potentially be performed by different systems, applications, or modules. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations.

For example, whilst method 300 is described as grouping data into windows after converting the data into symbolic representations, in alternative embodiments, it is possible that data is grouped into windows and then the data in each window converted into symbolic representations. Furthermore, the embedding model could possibly be initialised before or in parallel to the pre-processing steps. Additionally, whilst the allocating of windows of data into particular shards is described as occurring entirely before pre-training and fine-tuning, in alternative embodiments, windows of data may be allocated into shards during or throughout pre-training and/or fine-tuning as required for training and/or fine-tuning data for the model.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

1. A computer implemented method for training a vector embedder to generate vector embeddings for non-natural language data, the method including:
receiving the non-natural language data including a plurality of records, each record including a plurality of attributes;
grouping the records into a plurality of windows based on a respective subject attribute of the records, each window including a predetermined number of records;
sorting the windows in order based on an entropy value of each window; and
training a deep learning model to vectorize the non-natural language data by initially training the deep learning model with a set of windows having an entropy value lower than a threshold entropy value to predict one or more attributes of a record in each window based on the other attributes of the records in the window.

2. The computer implemented method of claim 1, wherein training the deep learning model to vectorize the non-natural language data further includes training the deep learning model with a set of windows having an entropy value higher than the threshold entropy value.

3. The computer implemented method of claim 1, wherein training the deep learning model to vectorize the non-natural language data further includes training the deep learning model with progressive sets of windows having entropy values along a continuum of entropy values.

4. The computer implemented method of claim 1, further including converting one or more of the plurality of attributes of each record into a symbolic representation of the respective attribute.

5. The computer implemented method of claim 1, wherein each record in a respective window shares a common value for the subject attribute with each other record in the respective window.

6. The computer implemented method of claim 1, wherein the one or more windows are sorted based on a frequency of occurrence of the subject attribute.

7. The computer implemented method of claim 1, wherein the windows are allocated to shards, each shard including one or more windows based on similarity with respect to other windows.

8. The computer implemented method of claim 7, wherein one or more shards respectively include substantially similar windows.

9. The computer implemented method of claim 7, wherein one or more shards respectively include substantially dissimilar windows.

10. The computer implemented method of claim 7, wherein similarity between windows is determined by calculating a minimum spanning tree between windows based on a string distance computed between the windows.

11. The computer implemented method of claim 1, wherein training the deep learning model includes pre-training the deep learning model based on a pretext task in respect of an object attribute.

12. The computer implemented method of claim 11, wherein the pre-training includes training the deep learning model based on the pretext task of predicting a value of the object attribute of a record in a window based on the other attributes of the record and other records in the window, and wherein the object attribute to predict is prefixed by a first special reserved symbol when inputting the window into the deep learning model; and wherein the output of the deep learning model is prefixed by the first special reserved symbol.

13. (canceled)

14. The computer implemented method of claim 1, wherein pre-training begins with windows having records with relatively common object attribute values and progresses to windows having records with rarer object attribute values.

15. The computer implemented method of claim 1, wherein training the deep learning model includes fine-tuning the deep learning model based on a fine-tuning task in respect of a record in each window, and wherein the fine-tuning includes updating the deep learning model according to a contrastive loss function, and/or wherein fine-tuning begins with windows having records with relatively common subject attribute values and progresses to windows having records with rarer subject attribute values.

16. The computer implemented method of claim 15, wherein the fine-tuning includes training the deep learning model based on the fine-tuning task of predicting the final record in each window based on the other records of the window.

17. The computer implemented method of claim 16, wherein the final record to predict is prefixed by a second special reserved symbol when inputting the window into the deep learning model; and wherein the output of the deep learning model is prefixed by the second special reserved symbol, and wherein the fine-tuning includes updating the deep learning model to minimize a distance between embeddings of the inputs and outputs of the deep learning model.

18. (canceled)

19. (canceled)

20. (canceled)

21. The computer implemented method of claim 1, wherein the deep learning model includes a transformer architecture.

22. The computer implemented method of claim 1, wherein the non-natural language data is transaction data, the transaction data including a plurality of transaction records; wherein each transaction record includes an entity, a counterparty, an amount, a date and a time, and the method further includes converting one or more attributes of each transaction record into a symbolic representation of the respective attribute, wherein converting the one or more attributes of each transaction record into the symbolic representation of the respective attribute includes one or more of:
converting an amount into a quantile of a predetermined range;
converting a date into a day of the week and a month of the year; and
converting a time into an hour of the day.

23. (canceled)

24. The computer implemented method of claim 22, wherein the subject attribute of each transaction record is the entity, and wherein the object attribute of each transaction record is the counterparty.

25. (canceled)

26. A computer processing system comprising:
a processing unit; and
a non-transitory computer-readable storage medium storing instructions, which when executed by the processing unit, cause the processing unit to perform the method comprising:
receiving the non-natural language data including a plurality of records, each record including a plurality of attributes;
grouping the records into a plurality of windows based on a respective subject attribute of the records, each window including a predetermined number of records;
sorting the windows in order based on an entropy value of each window; and
training a deep learning model to vectorize the non-natural language data by initially training the deep learning model with a set of windows having an entropy value lower than a threshold entropy value to predict one or more attributes of a record in each window based on the other attributes of the records in the window.

27. (canceled)
